(19) United States
(12) Patent Application Publication
(10) Pub. No.: US 2015/0223155 A1
(43) Pub. Date: Aug. 6, 2015

(54) SYSTEM INFORMATION FOR DEVICE-TO-DEVICE DISCOVERY

(71) Applicants: Samuli TURTINEN, Ii (FI); Timo KOSKELA, Oulu (FI); Sami-Jukka HAKOLA, Kempele (FI); BROADCOM CORPORATION, Irvine, CA (US)

(72) Inventors: Samuli Turtinen, Ii (FI); Timo Koskela, Oulu (FI); Sami-Jukka Hakola, Kempele (FI)

(73) Assignee: BROADCOM CORPORATION, Irvine, CA (US)

(21) Appl. No.: 14/429,604

(22) PCT Filed: Sep. 17, 2013
(86) PCT No.: PCT/IB2013/058603

§ 371 Date: Mar. 19, 2015

(30) Foreign Application Priority Data
Sep. 27, 2012 (GB) 1217314.2

(51) Int. Cl. H04W 48/16; H04W 76/02; H04W 68/00; H04W 48/08

(52) U.S. Cl. CPC H04W 48/16; H04W 48/08; H04W 76/02; H04W 68/00; H04W 84/12

(57) ABSTRACT

In radio communication networks, such as the Long Term Evolution (LTE) or the LTE-Advanced (LTE-A) of the 3rd Generation Partnership Project (3GPP), a user equipment (UE) may communicate with another UE via a base station. UEs may also communicate directly with each other by applying resources dedicated by the network for a device-to-device (D2D) direct communication. One part of device-to-device (D2D) communication is discovery to find other interesting peers (in general a peer can mean an application, user, service, device, etc.) in proximity. The discovery can be implemented either using the direct radio signals between the devices or it may utilise network side in the process. The same discovery process may be utilised in relation to small cells. A system information block SIB comprising information on small cell discovery and D2D is generated. Any change in the SIB is indicated in a paging message. The UE receiving the paging message is thereby requested to also receive the related SIB to apply the changed information.

### TECHNICAL FIELD

The present invention relates to apparatus and methods for use in communication networks. The exemplary and non-limiting embodiments of the invention relate generally to wireless communication networks.

### BACKGROUND

In radio communication networks, such as the Long Term Evolution (LTE) or the LTE-Advanced (LTE-A) of the 3rd Generation Partnership Project (3GPP), network planning comprises the use of common base stations (Node B, NB). User equipment (UE) may communicate with another UE via the base station(s), for example. Alternatively, it is proposed that the UEs may communicate directly with each other by applying resources dedicated by the network for a device-to-device (D2D) direct communication. The D2D communication has proven to be network efficient by offloading the traffic processed in the base station(s), for example.

One part of device-to-device (D2D) communication is discovery. The discovery means basically finding other interesting peers (in general a peer can mean an application, user, service, device, etc.) in proximity. The discovery can be implemented either using the direct radio signals between the devices or it may utilise network side in the process. The same discovery process may be utilised in relation to small cells.

### SUMMARY

According to a first aspect of the present invention, there is provided apparatus for use in user equipment, the apparatus comprising a processing system configured to: detect one or more information elements received in a paging message indicating a changed system information related to local area connectivity; and acquire on the basis of the detection a system information block comprising information on at least two separate functions related to local area connectivity.

According to a second aspect of the present invention, there is provided apparatus for use in a communication system, the apparatus comprising a processing system configured to: generate a system information block comprising information on at least two separate functions related to local area connectivity; and control the transmission of the system information block.

According to a third aspect of the present invention, there is provided a method in a communication system, the method comprising: generating a system information block comprising information on at least two separate functions related to local area connectivity; and controlling the transmission of the system information block.

According to a fourth aspect of the present invention, there is provided a method in user equipment, the method comprising: receiving a paging message;

detecting one or more information elements in the paging message indicating a changed system information related to local area connectivity; and acquiring on the basis of the detection a system information block comprising information on at least two separate functions related to local area connectivity.

The processing systems described above may comprise at least one processor; and at least one memory including computer program instructions, the at least one memory and the computer program instructions being configured to, with the at least one processor, cause the apparatus at least to perform as described above.

There may also be provided a computer program comprising a set of instructions which when executed on a processing system cause the processing system to perform as described above. The computer program may be provided in or on a computer-readable medium.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates schematically an example of a communication environment;

FIGS. 2 and 3 are flowcharts illustrating schematically example embodiments of the invention; and

FIGS. 4A and 4B illustrate schematically examples of apparatus applying some embodiments of the invention.

### DETAILED DESCRIPTION

Some embodiments of the present invention are applicable to user equipment (UE), a base station, eNodeB, a corresponding component, and/or to any communication system or any combination of different communication systems that support required functionality.

The protocols used, the specifications of communication systems, servers and user equipment, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the Universal Mobile Telecommunications System (UMTS) radio access network (UTRAN), HSPA (High Speed Packet Access), Long Term Evolution (LTE®, known also as Evolved UMTS Terrestrial Radio Access Network E-UTRAN), Long Term Evolution Advanced (LTE-A), Wireless Local Area Network (WLAN) based on IEEE 802.11 standard, Worldwide Interoperability for Microwave Access (WiMAX®), Bluetooth®, personal communications services (PCS) and systems using ultra-wideband (UWB) technology. IEEE refers to the Institute of Electrical and Electronics Engineers. For example, LTE® and LTE-A are developed by the Third Generation Partnership Project 3GPP.

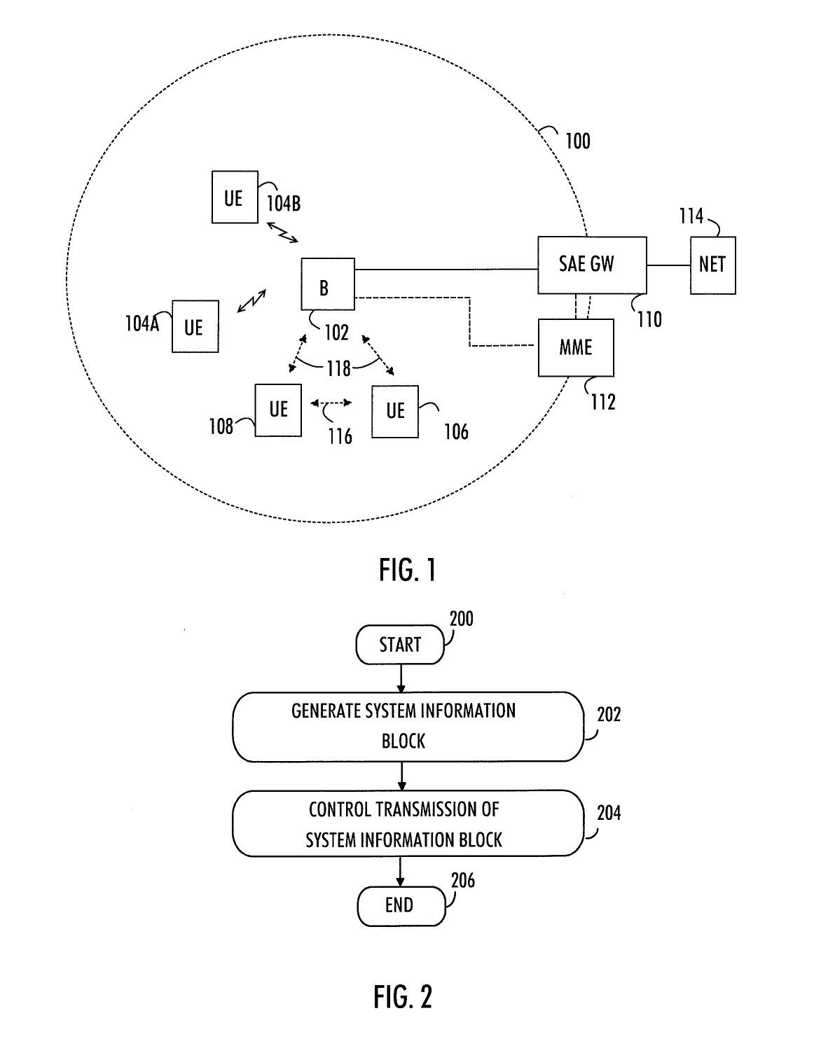

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the details of the functions, structures, elements and the protocols used in or for communication are well known to the person skilled in the art and therefore need not be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway 110 and an MME (Mobility Management Entity) 112. The SAE Gateway 110 provides a connection to Internet 114. FIG. 1 shows a base station or an eNodeB 102 serving a cell 100. In this example, the eNodeB 102 is connected to the SAE Gateway 110 and the MME 112.

The eNodeBs (enhanced Node Bs) of a communication system may host the functions for Radio Resource Management: Radio Bearer Control, Radio Admission Control, Connection Mobility Control, Dynamic Resource Allocation (scheduling). The MME 112 is responsible for the overall UE control in mobility, session/call and state management with assistance of the eNodeBs through which the UEs connect to the network. The SAE GW 110 is an entity configured to act as a gateway between the network and other parts of a communication network such as the Internet for example. The SAE GW may be a combination of two gateways, a serving gateway (S-GW) and a packet data network gateway (P-GW).

The eNodeB 102 may provide radio coverage to a cell 100. The cell 100 may be a macrocell, a microcell, or any other type of cell where radio coverage is present. Further, the cell 100 may be of any size or form, depending on the antenna system utilised. The eNodeB 102 may be used in order to provide radio coverage to the cell 100. The eNodeB 102 may control a cellular radio communication link established between the eNodeB 102 and terminal devices or user equipment 104A and 104B located within the cell 100. These communication links marked with solid arrows may be referred as conventional communication links for end-to-end communication, where the source device transmits data to the destination device via the base station 100. Therefore, the user equipment 104A and 104B may communicate with each other via the base station 102. The user equipment may be a user equipment of a cellular communication system, e.g. a computer (PC), a laptop, a handheld computer, a mobile phone, or any other user terminal or user equipment capable of communicating with the cellular communication network.

Local area access improvements are predicted to be the next evolution steps in future communication systems. As an option a separate frequency layer may be dedicated for small cell deployment. The small cells are considered to be low power eNodeBs. The operation in a small cell frequency layer can be controlled by the overlaying macro cell that provides the coverage in another frequency layer over a coverage area of multiple small cells. The control relationship between the macro and small cell layer varies depending on the selected architecture.

In addition to or instead of the conventional communication links, direct device-to-device (D2D) connections may be established among terminal devices. Direct communication links between two devices may be established, e.g. between terminal devices or user equipment 106 and 108 in FIG. 1. A direct communication link 116 marked with a dashed arrow may be based on any radio technology such that the terminal devices or user equipment 106 and 108 involved in the direct communication may apply communication according to any of a plurality of radio access technologies. The eNodeB 102 may be responsible for controlling the direct communication link 116, as shown with dotted, bi-directional lines 118 in FIG. 1. The radio access technology of the direct communication link 116 may operate on the same frequency band as the conventional communication link and/or outside those frequency bands to provide the arrangement with flexibility. Thus, the eNodeB 102 may be responsible for allocating radio resources to the direct communication link 116 as well as for the conventional communication links. Alternatively, the UEs 106, 108 may perform auto-selection of D2D resources from a common pool of resources.

Generally, eNodeBs send system information to the user equipment in their area. The system information may comprise information related to UE discovery and D2D communications to be received by discovery and D2D communication capable UEs.

One aspect to be taken into account is how to enable discovery and D2D communication-capable UEs to be notified about a system information change without impacting on UEs that are not participating in discovery or D2D communications.

In many present systems, change of system information (other than specific emergency information) only occurs at specific radio frames. Thus, the concept of a modification period is used. System information may be transmitted a number of times with the same content within a modification period, as defined by its scheduling. The modification period may be configured by system information.

In an embodiment, when the or some of the system information is changed by the network, it first notifies the UEs about this change, i.e. this may be done throughout a modification period. In the next modification period, the network transmits the updated system information. Upon receiving a change notification, the UE may acquire the new system information immediately from the start of the next modification period. The UE applies the previously acquired system information until the UE acquires the new system information.

In an embodiment, the mechanism used to inform UEs about changed system information is the transmission of System Information Blocks (SIB). The network may transmit a System Information Block denoted as SystemInformationBlockType1 (SIB 1) which comprises cell access information and information on the scheduling of other system information which is transmitted in other SIBs. In an embodiment, SIB 1 comprises a schedulingInfoList parameter which indicates which SIBs are transmitted by the network.

In an embodiment, a system information block comprising information on small cell discovery or device-to-device communication is created.

FIG. 2 is a flowchart illustrating schematically an example embodiment of the invention. The apparatus employing this embodiment may be a base station or an eNodeB of a communication system or network, for example. The process starts at step 200.

In step 202, the apparatus is configured to generate a System Information Block which may be denoted as SystemInformationBlockTypeX (wherein X is a predetermined integer number for the block), which conveys information about at least two separate functions that relate to local area connectivity, such as discovery or device-to-device communication. In an embodiment, the two mechanisms are small cell discovery and D2D discovery functions. In another embodiment, the two mechanisms are D2D discovery and D2D communication functions.

In step 204, the apparatus is configured to control the transmission of the system information block, that is, in an embodiment, to cause the system information block to be transmitted as required.

The process ends in step 206.

In an embodiment, an eNodeB of the network transmits discovery and D2D related information elements in paging messages in paging control channel PCCH.

In an embodiment, the eNodeB may transmit a D2D-Indication-parameter to indicate a D2D SIB information change. The eNodeB may further transmit a D2D-function-parameter to indicate whether the D2D SIB information change applies for a D2D discovery or D2D communication function.

In an embodiment, the eNodeB may transmit a discovery-Indication-parameter to indicate a discovery SIB information change. The eNodeB may further transmit a discovery-function-parameter to indicate whether the discovery SIB information change applies for small cell discovery or D2D discovery function.

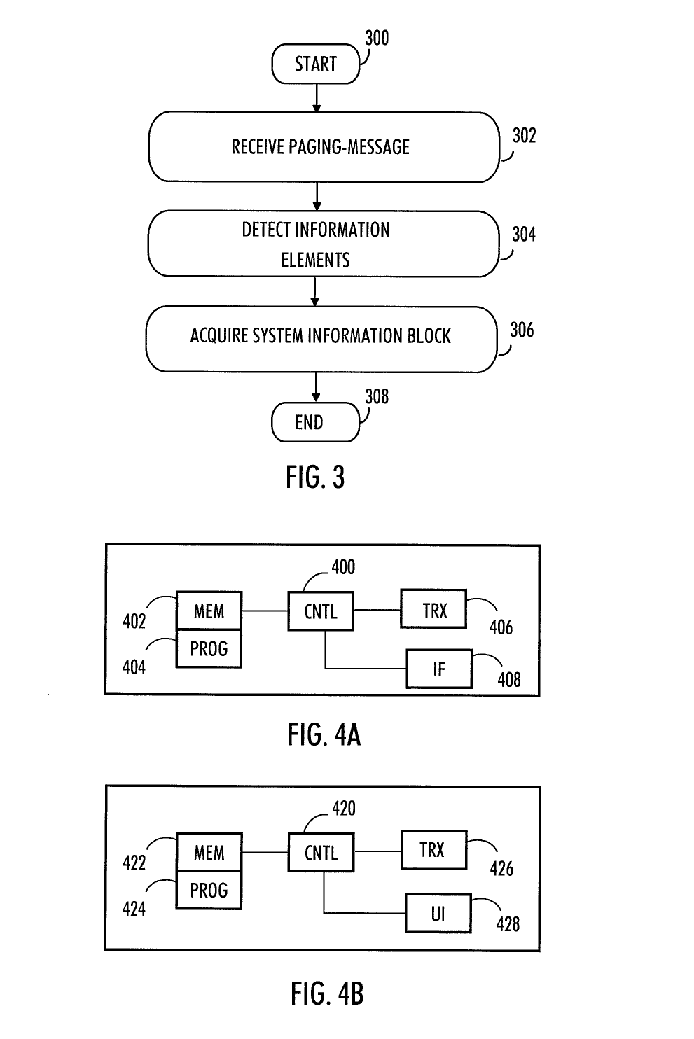

FIG. 3 is a flowchart illustrating schematically an example embodiment of the invention. The apparatus employing this embodiment may be user equipment of a communication system or network, for example. The process starts at step 300.

In step 302, the apparatus is configured to receive a paging message.

In step 304, the apparatus is configured to detect one or more information elements in the received paging message indicating a changed system information related to local area connectivity, such as discovery or device-to-device communication.

In step 306, the apparatus is configured to acquire on the basis of the detection a system information block comprising information on at least two separate functions related to local area connectivity. In an embodiment, the apparatus acquires the block only if the apparatus is discovery or device-to-device capable.

The process ends in step 308.

Thus in an embodiment, if the UE is discovery/D2D capable and the discovery/D2D-Indication information element is included in the Paging message, respectively, and the schedulingInfoList in SystemInformationBlockType1 indicates that SystemInformationBlockTypeX is present, the UE should re-acquire SystemInformationBlockTypeX.

In another embodiment, if the discovery/D2D-Indication information element is present in the Paging message, it indicates if the changed information is for small cell discovery or D2D discovery function or for D2D discovery or D2D communication function, respectively. If the discovery/D2D-function information element is not present but the discovery/D2D-Indication information element is present, the re-acquiring of SystemInformationBlockTypeX applies for both small cell discovery and D2D discovery functions or D2D discovery and D2D communication functions, respectively.

In an embodiment, if the UE is performing small cell discovery and D2D discovery OR D2D discovery and D2D data communication at the same time, the UE is configured to re-acquire SystemInformationBlockTypeX in both cases regardless of the presence of a discovery/D2D-function IE in the Paging-message.

In an embodiment, the indication about the modified SIB and therefore the command to re-acquire SystemInformationBlockTypeX may be sent via Physical Downlink Control Channel PDCCH with a common discovery/D2D-RNTI (Radio Network Temporary Identifier) which is known by every discovery/D2D device. In one method of this embodiment, the indication is scheduled M-subframes before the beginning of the scheduling window (indicated via SchedulingInfoList information element) of SystemInformationBlockTypeX. The value of M may be positive, negative or zero, and can be specified as fixed or is configurable by the network. The value of M may be transmitted via SIB.

When receiving a paging message from an eNodeB, the UE is configured to determine the information elements of the paging message.

If the UE detects that a D2D-Indication element is included and the UE is D2D capable, the UE is configured to check if the schedulingInfoList of SIB1 indicates that SystemInformationBlockTypeX is present.

Further if a D2D-function element is included and indicates changes for D2D discovery and the UE is performing D2D discovery, the UE is configured to acquire SystemInformationBlockTypeX, waiting until the next system information modification period boundary. Otherwise, if a D2D-function element is included and indicates changes for D2D communication and the UE is performing D2D communication, the UE is configured to acquire SystemInformationBlockTypeX, waiting until the next system information modification period boundary.

If the UE detects that the discovery-Indication element is included and the UE is discovery capable, the UE checks if the schedulingInfoList of SIB 1 indicates that SystemInformationBlockTypeX is present.

Further if a discovery-function element is included and indicates changes for small cell discovery and the UE is performing small cell discovery, the UE is configured to acquire SystemInformationBlockTypeX waiting until the next system information modification period boundary.

If a discovery-function element is included and indicates changes for D2D discovery and the UE is performing D2D discovery, the UE is configured to acquire SystemInformationBlockTypeX, waiting until the next system information modification period boundary.

In an embodiment, if the UE is performing either a device-to-device discovery function or a device-to-device communication function, and the information element indicates that other one of the functions changes, the System Information Block is not acquired.

In an embodiment, if the UE is performing either a small cell discovery function or a device-to-device discovery function, and the information element indicates that other one of the functions changes, the System Information Block is not acquired.

FIG. 4A illustrates schematically a simplified example of a device in which some embodiments of the invention may be applied. In some embodiments, the device may be a base station or an eNodeB of a communication system or network. The device may be a part or a section of a base station or an eNodeB.

FIG. 4B illustrates schematically a simplified example of a device in which some embodiments of the invention may be applied. In some embodiments, the device may be user equipment UE or a respective device communicating with a base station or a NodeB of a communications system. The device may be a part or a section of user equipment.

It should be understood that the apparatus are depicted herein as examples illustrating some embodiments. It is apparent to a person skilled in the art that the devices may also comprise other functions and/or structures and not all described functions and structures are required. Although the devices have been depicted as single entities, different modules and memory may be implemented in one or more physical or logical entities. In addition, each device may be a part of another device.

Referring to FIG. 4A, the device of the example includes one or more control circuitries or processing circuits (CNTL) 400 configured to control at least part of the operation of the device.

The device may comprise one or more memories (MEM) 402 for storing data. Furthermore the memory may store software (PROG) 404 executable by the control circuitry 400. The memory may be integrated in the control circuitry.

The device may comprise a transceiver (TRX) 406. The transceiver is operationally connected to the control circuitry 400. It may be connected to an antenna arrangement (not shown). The device may also comprise a connection to a transceiver instead of a transceiver.

The device may comprise an interface (IF) 408. The interface is operationally connected to the control circuitry 400. The device may be connected to other network elements of the communication system or network via the interface.

The software 404 may comprise a computer program comprising program code means adapted to cause the control circuitry 400 of the device to control a transceiver 406.

The software 404 may comprise a computer program comprising program code means adapted to cause the control circuitry 400 of the device to generate a system information block comprising information on at least two separate functions related to local area connectivity such as discovery or device-to-device communication and to control the transmission of the system information block.

FIG. 4B illustrates schematically a simplified example of user equipment UE or a respective device. The device of the example includes one or more control circuitries or processing circuits (CNTL) 420 configured to control at least part of the operation of the device.

The device may comprise one or more memories (MEM) 422 for storing data. Furthermore the memory may store software (PROG) 424 executable by the control circuitry 420. The memory may be integrated in the control circuitry.

The device may comprise a transceiver (TRX) 426. The transceiver is operationally connected to the control circuitry 420. It may be connected to an antenna arrangement (not shown). The device may also comprise a connection to a transceiver instead of a transceiver.

The software 424 may comprise a computer program comprising program code means adapted to cause the control circuitry 420 of the device to control a transceiver 426.

The software 424 may comprise a computer program comprising program code means adapted to cause the control circuitry 400 of the device to receive a paging message; detect one or more information elements in the paging message indicating a changed system information related to local area connectivity such as discovery or device-to-device communication; and acquire on the basis of the detection a system information block comprising information on at least two separate functions related to local area connectivity if the user equipment is discovery or device-to-device capable.

The device may further comprise a user interface (UI) 428 operationally connected to the control circuitry 420. The user interface may comprise a display which may be touch sensitive, a keyboard or keypad, a microphone and a speaker, for example.

The steps and related functions described in the above and attached figures are in no absolute chronological order, and some of the steps may be performed simultaneously or in an order differing from the given ones. Other functions can also be executed between the steps or within the steps. Some of the steps can also be left out or replaced with a corresponding step.

The apparatus or controllers able to perform the above-described steps may be implemented as an electronic digital computer, processing system or a circuitry which may comprise a working memory (RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term “circuitry” refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of “circuitry” applies to all uses of this term in this application. As a further example, as used in this application, the term “circuitry” would also cover an implementation of merely a processor (or multiple processors) or a portion of a processor and its (or their) accompanying software and/or firmware. The term “circuitry” would also cover, for example and if applicable to the particular element, a baseband integrated circuit or application-specific integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. Apparatus for use in user equipment, the apparatus comprising a processing system configured to:
detect one or more information elements received in a paging message indicating a changed system information related to local area connectivity; and
acquire on the basis of the detection a system information block comprising information on at least two separate functions related to local area connectivity.

2. Apparatus according to claim 1, the apparatus being configured to:
determine from a received system information block, which comprises information on information blocks transmitted by the communication system, if a system information block comprising information on small cell and device-to-device discovery or device-to-device discovery and device-to-device communication is transmitted by the system, and
acquire the block if it is transmitted.

3. Apparatus according to claim 1, the apparatus being configured to:
detect an information element indicating device-to-device system information change;
and detect an information element indicating whether the change is related to device-to-device discovery or device-to-device communication.

4. Apparatus according to claim 3, wherein if the apparatus is performing either a device-to-device discovery function or a device-to-device communication function, and the information element indicates that the other one of the functions changes, the block is not acquired.

5. Apparatus according to any of claim 1, the apparatus being configured to:
detect an information element indicating discovery system information change; and
detect an information element indicating whether the change is related to small cell discovery or device-to-device discovery.

6. Apparatus according to claim 5, wherein if the apparatus is performing either a small cell discovery function or a device-to-device discovery function, and the information element indicates that the other one of the functions changes, the block is not acquired.

7. Apparatus according to any of claim 1, wherein the apparatus is user equipment.

8. Apparatus according to claim 7, wherein the user equipment is a mobile device.

9. Apparatus according to any of claim 1, wherein the apparatus is a user equipment of a Long Term Evolution based communication system.

10. Apparatus for use in a communication system, the apparatus comprising a processing system configured to:
generate a system information block comprising information on at least two separate functions related to local area connectivity; and
control the transmission of the system information block.

11. Apparatus according to claim 10, the apparatus being configured to:
control transmission of an information element in a paging message indicating changed system information related to small cell discovery or device-to-device communication.

12. Apparatus according to claim 10, wherein the system information block comprises information on small cell discovery and device-to-device discovery functions.

13. Apparatus according to claim 10, wherein the system information block comprises information on device-to-device discovery and device-to-device communication functions.

14. Apparatus according to claim 11, wherein the information element in the paging message indicates device-to-device system information change.

15. Apparatus according to claim 14, wherein the information element in the paging message indicates whether device-to-device system information change applies for device-to-device discovery or device-to-device communication.

16-31. (canceled)

32. A method in user equipment, the method comprising:
receiving a paging message;
detecting one or more information elements in the paging message indicating a changed system information related to local area connectivity; and
acquiring on the basis of the detection a system information block comprising information on at least two separate functions related to local area connectivity (116).

33. A method according to claim 32, comprising:
receiving a system information block comprising information on information blocks transmitted by the communication system;
determining from the received system information block if a system information block comprising information on small cell discovery or device-to-device communication is transmitted by the system; and
acquiring the block if it is transmitted.

34. A method according to claim 32, comprising:
detecting an information element indicating device-to-device system information change; and
detecting an information element indicating whether the change is related to device-to-device discovery or device-to-device communication.

35. A method according to any of claim 32, comprising:
detecting an information element indicating discovery system information change; and
detecting an information element indicating whether the change is related to small cell discovery or device-to-device discovery.

36. (canceled)

37. A computer program comprising a set of instructions which when executed on a processing system cause the processing system to perform the steps of any of claim 32.

38-39. (canceled)
